(19) United States
(12) Patent Application Publication
(10) Pub. No.: US 2009/0050006 A1
(43) Pub. Date: Feb. 26, 2009

(54) TRANSFER PLATE FOR A TRANSFER CYLINDER OF A PRINTING PRESS

(75) Inventors: Thomas Kandlbinder, Augsburg (DE); Claudius Wurm, Stadtbergen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/037,615

(22) Filed: Feb. 26, 2008

(30) Foreign Application Priority Data
Feb. 28, 2007 (DE) 10 2007 009 810.5

(51) Int. Cl. B41N 1/00

(52) U.S. Cl. 101/395

(57) ABSTRACT

A transfer plate, particularly a blanket plate, for a transfer cylinder, with a plate-like support, where a blanket being used for ink transfer is applied to a first side of the plate-like support, and where a film is applied to a second side of the plate-like support that is opposite from the first side, via which film a packing height of the transfer plate on a transfer cylinder can be predetermined. The film is applied to the second side of the plate-like support in such a way that a surface of the support covered by the film on the second side is smaller than a surface of the support covered by the blanket on the first side.

This application claims the priority of German Patent Document No. 10 2007 009 810.5, filed Feb. 28, 2007, the disclosure of which is expressly incorporated by reference herein.

### BACKGROUND AND SUMMARY OF THE INVENTION

The invention relates to a transfer plate for a transfer cylinder of a printing press.

A printing couple of a printing press, particularly a web-fed printing press, includes, in addition to a plate cylinder and a transfer cylinder, an inking system as well as, if applicable, a dampening system. At least one printing plate is arranged on the plate cylinder and at least one transfer plate is arranged on the transfer cylinder. Plate cylinders are also designated as engraving cylinders and transfer cylinders are also called blanket cylinders.

Blanket plates in particular are used as transfer plates in web-fed printing presses, whereby a blanket plate has a plate-like support. A blanket being used for ink transfer is applied to a first side of the plate-like support. A film is applied to a second side of the plate-like support that is opposite from the first side, wherein a packing height of the transfer plate on a transfer cylinder can be determined by the film. The plate-like carrier of the blanket plate can be manufactured of a metallic material or of a plastic. Blanket plates are also called metal underpackages.

In the case of blanket plates known from practice, the blanket as well as the film are applied to the plate-like support in such a way that a surface of the plate-like support covered by the film in the region of the second side corresponds to the surface covered by the blanket on the first side of the plate-like support.

Starting herefrom, the present invention is based on the objective of creating a novel transfer plate for a transfer cylinder of a printing press with improved printing properties.

According to the invention, the film is applied to the second side of the plate-like support in such a way that a surface of the support covered by the film on the second side is smaller than a surface of the support covered by the blanket on the first side.

In terms of the present invention, it is provided that by recessing the film in a targeted manner on the second side of the plate-like support, the film can be applied to the plate-like support in such a way that the surface of the support covered by the film on the second side is smaller than a surface of the support covered by the blanket on the first side. This makes it possible to improve printing quality.

According to an advantageous development of the invention, in the axial direction, the covering of the plate-like support by the film corresponds to the covering of the plate-like support by the blanket, whereas, in the circumferential direction, the covering of the plate-like support by the film is smaller than the covering of the plate-like support by the blanket.

The plate-like support preferably features a leading end and a trailing end that are used to clamp the transfer plate, whereby the edges of the film adjacent to the leading end and trailing end have a distance of between 4 mm and 10 mm from the bending radius of the leading end and/or trailing end, and whereby a section having a width of between 8 mm and 16 mm is not covered by the film in the center between the leading end and the trailing end.

Preferred developments of the invention are yielded from the following description. Without being limited hereto, exemplary embodiments of the invention are explained in greater detail on the basis of the drawings.

### BRIEF DESCRIPTION OF THE DRAWINGS

FIG. 1 is a schematic side view of a transfer plate known from the prior art.

FIG. 2 is a schematic side view of transfer plate in accordance with the principles of the present invention.

FIG. 3 is a top view of the transfer plate of FIG. 2.

### DETAILED DESCRIPTION OF THE DRAWINGS

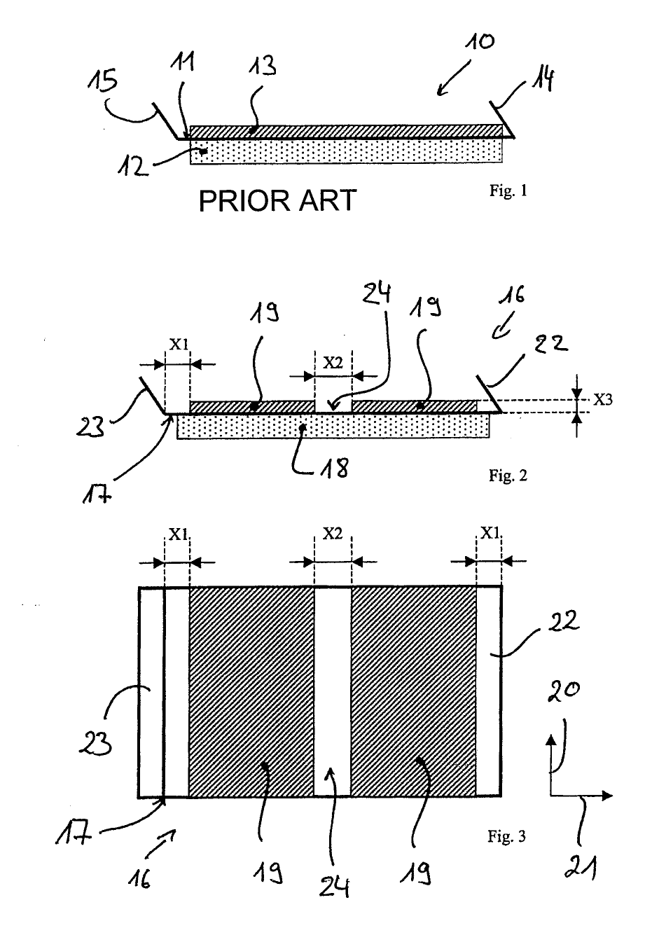

Initially a transfer plate known from the prior art will be described in reference to FIG. 1 in the following before an inventive transfer plate is described in detail in reference to FIGS. 2 and 3.

FIG. 1 shows very schematically a transfer plate embodied as a blanket plate 10 that is known from the prior art, whereby the blanket plate has a plate-like support 11. A blanket 12 being used for ink transfer is applied to a first side of the plate-like support 11. A film 13 is applied to a second side of the plate-like support 11 that is opposite from the first side, via which film a packing height of the blanket plate 10 on a transfer cylinder can be predetermined. According to FIG. 1, the plate-like support features a leading end 14 and a trailing end 15 that are used to clamp the blanket plate 10. The blanket plate 10 can be clamped in a lockup slot of a transfer cylinder via the leading end 14 as well as the trailing end 15. The leading end 14 and the trailing end 15 are bent with respect to the plate-like support 11, namely forming so-called bending radii.

FIGS. 2 and 3 show a preferred embodiment of an inventive transfer plate embodied as a blanket plate 16. The blanket plate 16 in FIGS. 2 and 3 again has a plate-like support 17, whereby a blanket 18 is again applied to a first side of the plate-like support 17 and a film 19 is again applied to a second side that is opposite from the first side.

In terms of the present invention, the film 19 is applied to the second side of the plate-like support 17 in such a way that a surface of the support 17 covered by the film 19 on the second side is smaller than a surface of the support 17 covered by the blanket 18 on the first side.

As can be seen in FIG. 3 in particular, in the axial direction of the blanket plate 16 (arrow 20), the covering of the plate-like support 17 by the film 19 corresponds to the covering of the plate-like support 17 by the blanket 18. On the other hand, in the circumferential direction of the blanket 16 (arrow 21), the covering of the plate-like support 17 by the film 19 is smaller than the covering of the plate-like support 17 by the blanket 18.

The plate-like support 17 of the blanket plate 16 again has a leading end 22 as well as a trailing end 23. The inventive blanket plate 16 can be clamped on the transfer cylinder via the leading end 22 and the trailing end 23, whereby to do so the leading end 22 and the trailing end 23 engage in a lockup slot.

As is evident from FIGS. 2 and 3, the distance of the film 19 from the leading end 22 and the trailing end 23 is greater than the distance of the blanket 18 from the leading end 22 and the trailing end 23.

In other words, this means that the edges of the film 19 opposite from the leading end 22 and/or the trailing end 23 are at a greater distance from the bending radius of the leading end 22 and/or trailing end 23 than the corresponding edges of the blanket 18.

The distance X1 between the bending radius of the leading end 22 and/or trailing end 23 and an edge of the film 19 that is opposite from the respective bending radius is between 1 mm and 10 mm.

By recessing the film 19 adjacent to the bending radius of leading end 22 and trailing end 23, pressing the blanket against the plate cylinder in the region of the lockup slot can be reduced so that also printing the printing plate edges, which the blanket plate 16 rolls over in these regions, can be reduced.

According to an advantageous development of the invention, the plate-like support 17 of the blanket plate 16 has a section 24 that is not covered by the film 19 in the center between the leading end 22 and the trailing end 23, whereby, as viewed in the circumferential direction, the section 24 preferably has a width X2 of between 2 mm and 16 mm. The section 24 that is not covered by film 19 prevents edges of printing plates that are offset by 180° from having a negative impact on the printing quality.

The film applied to the second side of the plate-like support 17 has a thickness X3 of between 0.04 mm and 0.6 mm.

### List of Reference Numerals

Blanket plate

Plate-like support

Blanket

Film

Leading end

Trailing end

Blanket plate

Plate-like support

Blanket

Film

Axial direction

21 Circumferential direction

22 Leading end

23 Trailing end

24 Section

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A transfer plate, particularly a blanket plate, for a transfer cylinder, with a plate-like support, wherein a blanket for ink transfer is applied to a first side of the plate-like support, and wherein a film is applied to a second side of the plate-like support that is opposite from the first side, via which film a packing height of the transfer plate on the transfer cylinder can be predetermined, wherein the film is applied to the second side of the plate-like support in such a way that a surface of the plate-like support covered by the film on the second side is smaller than a surface of the plate-like support covered by the blanket on the first side.

2. The transfer plate according to claim 1, wherein in an axial direction, the covering of the plate-like support by the film corresponds to the covering of the plate-like support by the blanket.

3. The transfer plate according to claim 1, wherein in a circumferential direction, the covering of the plate-like support by the film is smaller than the covering of the plate-like support by the blanket.

4. The transfer plate according to claim 1, wherein the plate-like support features a leading end and a trailing end to clamp the transfer plate, wherein a distance of the film from the leading end and/or the trailing end is greater than a distance of the blanket from the leading end and/or the trailing end.

5. The transfer plate according to claim 4, wherein edges of the film feature a distance of between 1 mm and 10 mm from a bending radius of the leading end and/or trailing end.

6. The transfer plate according to claim 4, wherein the plate-like support has a section that is not covered by the film in a center between the leading end and the trailing end.

7. The transfer plate according to claim 6, wherein during operation the section not covered by the film is rolled over by a lockup slot of a plate cylinder cooperating with the transfer cylinder.

8. The transfer plate according to claim 6, wherein the section not covered by the film features a width of between 2 mm and 16 mm.

9. The transfer plate according to claim 1, wherein the film features a thickness of between 0.04 mm and 0.6 mm.

10. A transfer plate for a transfer cylinder, comprising:
a plate-like support;
a blanket applied to a first side of the plate-like support; and
a film applied to a second side of the plate-like support, wherein the first side is opposite from the second side;
wherein a surface area of the film is smaller than a surface area of the blanket.

11. The transfer plate according to claim 10, wherein an axial length of the film is a same length as an axial length of the blanket.

12. The transfer plate according to claim 10, wherein a circumferential length of the film is different from a circumferential length of the blanket.

13. The transfer plate according to claim 12, wherein the plate-like support includes a leading end and a trailing end and wherein a distance of a circumferential end of the film from the leading end and/or the trailing end is greater than a distance of a circumferential end of the blanket from the leading end and/or the trailing end.

14. The transfer plate according to claim 12, wherein the film is divided into a first section and a second section in a circumferential direction and wherein the film is discontinuous between the first and second sections.

15. The transfer plate according to claim 13 in combination with a transfer cylinder, wherein the leading end and the trailing end of the plate-like support are disposed within respective lockup slots of the transfer cylinder.

16. The transfer plate according to claim 10, wherein a circumferential end of the film is recessed from a circumferential end of the blanket.
